(19) United States
(12) Patent Application Publication
(10) Pub. No.: US 2009/0204660 A1
(43) Pub. Date: Aug. 13, 2009

(54) Service Oriented Architecture for a Life Science Instrument Infrastructure

(75) Inventor: Gary A. Chappell, San Francisco, CA (US)

Correspondence Address: LIFE TECHNOLOGIES CORPORATION;C/O INTELLEVATE, P.O. BOX 52050, MINNEAPOLIS, MN, 55402, US

(73) Assignee: Life Technologies Corporation, Carlsbad, CA (US)

(21) Appl. No.: 12/366,537

(22) Filed: Feb. 5, 2009

Related U.S. Application Data
(60) Provisional application No. 61/026,213, filed on Feb. 5, 2008.

(51) Int. Cl. G06F 15/16

(52) U.S. Cl. 709/201

(57) ABSTRACT

The present teachings relate to systems and methods of service oriented architecture for a life science instrument system infrastructure. According to various embodiments, the infrastructure can be comprised of different hardware components and software modules. These software modules can be separate modules of executable code that can create a larger infrastructure and operate independently of each other. According to various embodiments, the network can comprise a service oriented architecture that can utilize modules of code in combination with each other to create a life science instrument infrastructure. The infrastructure can be comprised of service oriented architecture that can comprise, for example, a shared-data architecture, a peer-to-peer architecture, a publish-subscribe architecture, or another type of architecture.

### BACKGROUND

This application claims a priority benefit under 35 U.S.C. § 119(e) from U.S. Provisional Application No. 61/026,213 filed Feb. 5, 2008, which is incorporated herein by reference.

Current systems and methods of life science instrument infrastructures can comprise a combination of large or monolithic software applications or components to perform the necessary business methods of a life science instrument. Each software component can comprise a collection of different executable segments. For the most part these executable segments do not communicate with each other, and they are not reusable.

Each life science instrument infrastructure can have a variety of users, who each have a number of different clearances, constraints, considerations, variations, and requirements that must be accounted for. The drawbacks of monolithic application or component software with such a system include: the lack of modularity; the lengthy processing time required by the infrastructure to run, process, and execute each of the monolithic software applications or components; the loss of focus on core competencies; inability to selectively update only one executable segment; and the difficulty and effort required to build and maintain such monolithic software applications. At the same time, if a system requires multiple types of clients or users with multiple types of constraints, separate software is often written for each user. A need exists to increase the modularity and reusability of life science instrument system infrastructure software, and reduce the amount of software code that needs to be designed and maintained to enable multiple categories of users to use the system infrastructure.

### SUMMARY

Various embodiments of the present teachings relate to a system, device, and method for a life science instrument infrastructure. A life science instrument herein can, in some embodiments, refer to a plurality of life science instruments. In some embodiments, life science instrument infrastructure can comprise various hardware and software components and the hardware components can comprise a life science instrument and one or more computers. The hardware can also comprise objects that connect to the one or more computers and/or to the life science instrument, for example, storage devices, displays, keyboards, optical reading devices, and various other devices. The hardware components can connect and communicate with each other in the life science instrument infrastructure. This connection can allow data transfer to occur, for example, to and from the one or more computers, to and from the life science instrument, and to and from both. This data transfer connection can comprise a direct connection, a local area network connection, an internet connection, a sneaker-net, or another form of connection. The life science instrument infrastructure can also connect to computers outside of the infrastructure. Such connection can be provided, for example, by an internet.

According to various embodiments, the life science instrument infrastructure can have various levels of security, restrictions, and constraints. This can be provided by implementing all of the software components, services, and data stores, on each computer and each life science instrument within the infrastructure. It could also be provided by implementing software components, services, and data stores on a centralized server computer. The various levels can be distinguished from one another by various user designations or categories of users. In an exemplary embodiment, the following user designations can be categorized and implemented by the infrastructure: technician user; scientist user; lab manager user. Depending, however, on the user that is accessing the infrastructure, the system can hide software components, services, and data stores from the user. This type of security feature can allow for multiple types of restrictions to be implemented within a single life science instrument infrastructure. Passwords can be required by the user and/or a licensing key.

According to various embodiments, the life science instrument infrastructure can comprise various modules of software (also referred to herein as “plumbing,”) that allow data transfer between the one or more computers and the life science instrument. In some embodiments, one or more of the modules can comprise one or more services. The software can comprise various types of network software, for example, service oriented architecture software, or another form of software. The use of service oriented architecture can enable software modules, for example, software services and data stores, to be re-used by multiple software components throughout the life science instrument infrastructure. In some embodiments, different software components can comprise one or more of the same software modules as used by another of the software components. The use of service oriented architecture can allow the components to share the software modules, as opposed to having separate but identical software modules for each component. Each of the software modules can be implemented for execution on each of the computers within the life science instrument infrastructure. In some embodiments, the life science instrument can also have software modules implemented for execution within the life science instrument. This reusability enabled by the software module sharing can reduce the amount of software and/or instructions that need to be written, maintained, and stored within the life science instrument infrastructure.

According to various embodiments, the life science instrument infrastructure can comprise a network that enables data transfer to and from each of the computers and each life science instrument of the life science instrument infrastructure. The network can comprise various service oriented architecture software, for example, shared-data, peer-to-peer, publish-subscribe, or another network. In the shared-data architecture, the software modules, for example, the software components stored on one computer, can send, persist, and receive data and instructions to and from a plurality of software services and data stores of the infrastructure through a server software component. These services and data stores can be located on the same computer, or on separate computers within the life science instrument infrastructure, or implemented within the instrument itself. The server software component can send, persist, and receive data and instructions to and from other server software components located on different computers of the infrastructure. Each software component can send, persist, and receive data and instructions to and from the server software component, and the server software component, in turn, can send, persist, and receive information to each of the software services and data stores. The services and data stores can be implemented within the same computer as the server software component or components, and/or implemented on separate computers of the infrastructure. In this style of architecture, the components can access, or share data, with the other components through the use of the server software.

In some embodiments, the service oriented architecture can comprise peer-to-peer architecture that can enable each of the software components to send, persist, and receive data and instructions directly with the software services and data stores. In this type of interaction, the software components, services, and data stores can comprise instructions that enable them to communicate with each other.

In some embodiments, the service oriented architecture can comprise publish-subscribe architecture that can enable software modules to publish a set of events or a set of instructions onto a bus. These events can be published on the life science instrument infrastructure system bus. Once the set of events or set of instructions is published, the bus can send out the published set to one or more of the software services that subscribe to that set. In this type of interaction, the software components request interaction with the software services and data stores, through the system bus.

### FIGURES

FIG. 1 is a schematic representation of hardware components that can comprise or be included in the life science instrument infrastructure, according to various embodiments of the present teachings.

FIG. 2 is a schematic diagram of software components that can be implemented in the different hardware components of the life science instrument infrastructure, according to various embodiments of the present teachings.

FIG. 3 is a schematic diagram of a shared-data instrument architecture implemented in a life science instrument infrastructure, according to various embodiments of the present teachings.

FIG. 4 illustrates a workflow diagram of a shared-data instrument architecture implemented in a life science instrument infrastructure, according to various embodiments of the present teachings.

FIG. 5A illustrates a left-side partial viewpoint of a peer-to-peer instrument architecture implemented in a life science instrument infrastructure, according to various embodiments of the present teachings, and the legend of which is shown in FIG. 5C.

FIG. 5B illustrates a middle partial viewpoint of the peer-to-peer instrument architecture implemented in a life science instrument infrastructure shown in-part in FIG. 5A, and the legend of which is shown in FIG. 5C.

FIG. 5C illustrates a right-side partial viewpoint of the peer-to-peer instrument architecture implemented in a life science instrument infrastructure, shown in-part in FIGS. 5A and 5B.

FIG. 6 is a schematic diagram of a publish-subscribe instrument architecture implemented in a life science instrument infrastructure, according to various embodiments of the present teachings.

### DESCRIPTION

According to various embodiments, a life science instrument infrastructure is provided that can comprise one or more computers, one or more software components implemented for execution on the one or more computers, a life science instrument, and one or more software components implemented for execution on the life science instrument. A data transfer connection is provided connecting the life science instrument to at least one of the one or more computers. The infrastructure can also comprise a network that can comprise a service oriented architecture implemented for execution on each of the one or more computers. According to various embodiments, the service oriented architecture software can network together the software components implemented for execution on the life science instrument and the software components implemented for execution on the one or more computers. According to various embodiments, the service oriented architecture can comprise shared-data architecture, peer-to-peer architecture, publish-subscribe architecture, client-server architecture, monolithic software architecture, or any combination thereof.

According to various embodiments, the life science instrument infrastructure can be networked using a method that can use one or more computers, one or more software components implemented for execution on the one or more computers, one or more life science instruments, and/or one or more life science instrument software components implemented for execution on the one or more life science instrument. The method can comprise generating a data transfer connection between the life science instrument and at least one of the one or more computers, and establishing a network between at least one of the life science instrument software components and at least one of the computer software components using service oriented architecture.

Various embodiments of the present teachings relate to systems and methods of service oriented architecture for a life science instrument infrastructure. According to various embodiments, the system or infrastructure can comprise a life science instrument, for example, a sequence detection systems (SDS) such as a polymerase chain reaction (“PCR”) instrument, a capillary electrophoresis (“CE”) instrument, or another type of life science instrument. In some embodiments the life science instrument can be comprised of a thermal cycler, for example, a thermal cycler adapted to heat and cool samples contained in the instrument, well plates, samples contained in the well plates, and the like. An exemplary PCR instrument can comprise a real-time PCR (“RT-PCR”) instrument, for example, the Applied Biosystems 7900HT (Applied Biosystems, Foster City, Calif.), and an exemplary CE instrument can comprise a multi-capillary CE instrument, for example, the Applied Biosystems 3730x1 (Applied Biosystems, Foster City, Calif.).

According to various embodiments, the infrastructure can also comprise one or more storage devices, one or more monitors, one or more printers, one or more other peripherals, and/or one or more other objects capable of connecting with a computer or a life science instrument. According to various embodiments, service oriented architecture (“SOA”) software programs, components, services, and other types of instructions can be implemented for execution into the one or more computers and into the instrument, and can be used to deliver the software architecture, or plumbing, throughout the system. In some embodiments, the SOA software can deliver the business logic elements, instrument specific elements, and application specific elements of the system, and/or other software modules, such as software applications, components, and services. Utilizing SOA software can allow the instrument infrastructure to support a diverse range of possible deployment configurations, constraints, and other variations, while at the same time it can allow each type of user to achieve their primary objective or objectives for using the system, for example, data collection, primary data analysis, secondary data analysis, other purposes, or a combination thereof. In some embodiments, access to achieving different objectives can be customized based on the specific user with different limitations of use being imposed on some classes or categories of users while not imposed on others.

### Hardware

Various embodiments of the present teachings can be implemented, in whole or in part, in digital electronic circuitry, or in computer hardware, firmware, software, or any combination thereof. Devices and methods of the infrastructure can be implemented in a computer program, software, code, or algorithm, that can be embodied in machine-readable medium or media, for example, electronic memory, CD-ROM, DVD, hard drives, or other storage devices or media. Various method steps can be performed by a programmable processor executing a program of instructions to perform functions and processes, by operating on input data and generating output data.

According to various embodiments, the present teachings can be implemented in one or more computer programs that can be executed on a programmable system that can comprise at least one programmable processor. The processor can transmit data and instructions to a data storage system or memory, for example, to data stores, data libraries, or other storage systems. The processor can also receive data and instructions from at least one input device, for example, a keyboard, a mouse, a barcode reader, an RFID reader, another object, or combination thereof. The processor can also transmit data and instructions to at least one output device, for example, a printer, a display, another object, or a combination thereof. The processor can also transmit and receive data from an instrument such as a capillary electrophoresis instrument, a PCR instrument, or another life science instrument.

According to various embodiments, the software of the system can comprise a group of software modules. The modules can together comprise the software elements of the instrument infrastructure, and can each operate within the system independently from the other modules. As referred to herein, a software module is a set of instructions or code, that can be compiled and executed. The software modules can each comprise, for example, a component, a service, an application, an algorithm, or another instruction that can be implemented in a high level procedural, object-oriented, service-oriented, or other high-level programming language. In some embodiments, each module of software can be implemented in a low-level language, for example, assembly, machine, or some other low-level language, if desired. Each computer module can be implemented into a service-oriented architecture or other type of architecture. The architecture can be constructed such that the modules can send, persist, and receive data and instructions to and from other modules. The code can be compiled, interpreted, or otherwise processed for execution.

According to some embodiments, various software modules, processes, methods, components, services, applications, instructions, and algorithms can be executed on processors that can comprise, for example, both general and special purpose microprocessors, such as, those manufactured by Intel Corp. or AMD Inc. The processors can also comprise digital signal processors, programmable controllers, or other processors or devices. The processor can send, persist, and retrieve instructions and data from a read-only memory and/or from a random access memory.

According to various embodiments, a computer implementing one or more aspects of the present teachings, can comprise one or more mass storage devices or data stores for storing data files, such as magnetic disks, internal hard disks, removable disks, magneto-optical disks, CD-ROMs, DVDs, Blu-Rays, or other types of disks or media. Memory or storage devices suitable for storing, encoding, or embodying computer program instructions, components, applications, services, or other forms of software and data, can comprise all forms of volatile and non-volatile memory. The memory can comprise semi-conductor devices, for example, random access memory (“RAM”), electronically programmable memory (“EPROM”), electronically erasable programmable memory (“EEPROM”), flash memory devices, magnetic disks, optical disks, other forms of memory or a combination thereof. Any of the foregoing can be supplemented by, or incorporated in, application-specific integrated circuits (“ASICs”).

According to various embodiments, the processors, workstations, instruments, data stores, servers, or other computer, information, or communications resources used to implement features of the present system infrastructure can be connected via a data transfer connection, for example, directly, or through a network. The direct connection can comprise a cable, USB connection, serial connection, firewire, or the like. The network can comprise a local area network (“LAN”), a wireless local area network (“WLAN”), an internet, a sneaker-net, another type of network, or a combination thereof.

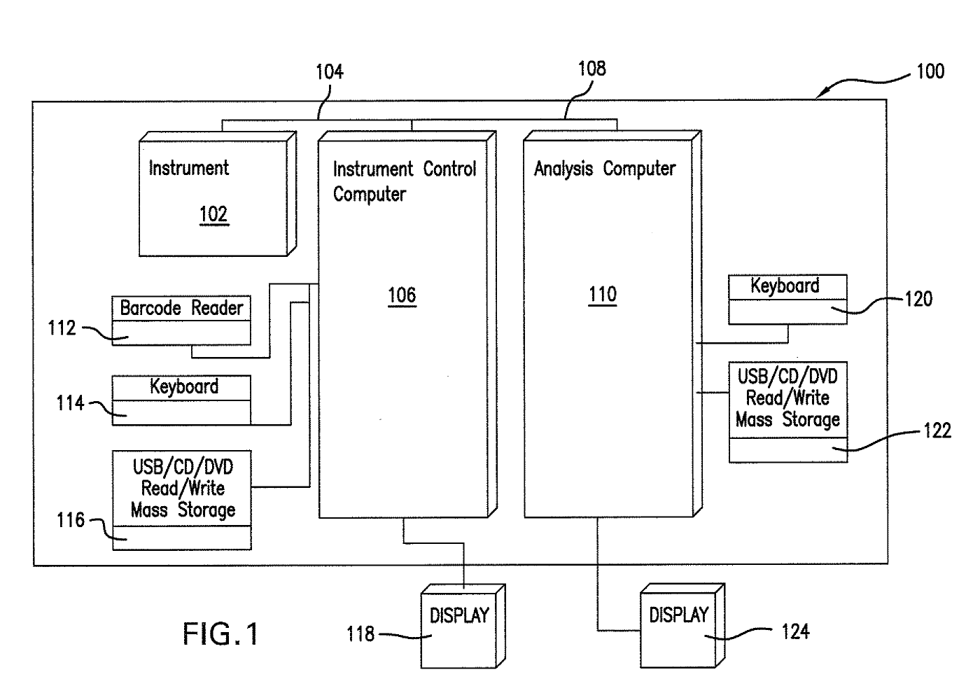

In some embodiments, the life science instrument infrastructure can comprise various hardware devices. For example, in addition to a life science instrument and one or more computers, the infrastructure can also comprise a USB read/write storage object or objects, a CD read/write storage object or objects, peripheral devices, any other device, hardware, or objects that can be used in a life science instrument infrastructure, or combination thereof. In some embodiments, system infrastructure can comprise the infrastructure hardware 100 shown in FIG. 1.

According to various embodiments, with reference to FIG. 1, infrastructure hardware 100 can comprise a CE instrument 102 that can be connected through a direct connection 104 to an instrument control computer 106. Instrument control computer 106 can be connected to an analysis computer 110 via a LAN 108. The instrument control computer 106 can also connect to other objects, for example, to a barcode reader 112, a keyboard 114, a universal serial bus (“USB”) storage read/write mass storage device 116, and/or a display or monitor 118. Instrument control computer 106 can request and receive data from CE instrument 102, and it can perform analysis on the data received. Instrument control computer 106 can send or share the data with analysis computer 110, and this can enable a secondary analysis to be conducted on the data received. Analysis computer 110 can be directly connected to various objects, for example, a keyboard 120, a USB read/write mass storage device 122, and a display or monitor 124.

According to various embodiments, the life science instrument infrastructure can comprise only one computer or it can comprise more than one computer. The present teachings are not meant to limit the number of computers and the variety of connections that can be used, and it will also be appreciated that when multiple computers are used each computer can send, persist, and receive data and instructions to and from the instrument, the other computers, and the other hardware components that can be apart of a life science instrument system or infrastructure. With multiple computers, each computer can send, persist, and receive data and instructions to and from each of the other computers of the infrastructure, or with other hardware components of the infrastructure, via a data transfer connection, for example, a LAN, a direct connection, an internet, a sneaker-net, or by another method of connection. By connecting the computers via a network, software modules on one computer can send, persist, and retrieve data from software modules on another computer of the system or infrastructure.

According to various embodiments, the one or more computers implemented into the infrastructure can connect with the instrument directly through a data transfer connection. The data transfer connection can comprise, for example, a cable or cord, a network such as a LAN, an internet, or some other method of connection that can allow for the computers to send and receive data directly from the instrument. According to various embodiments, the instrument can be implemented with firmware, software, or other instructions that can instruct the instrument to proceed with a run, reaction, process, or other analysis, for example, a daemon or other background process, program, component, or service. The computer can also be implemented with firmware, software, or some other instructions that can read the results of an instrument run, reaction, process, calibration, or other analysis. In some embodiments, the instrument can transfer the data from the run or other analysis to the other computers contained within the infrastructure, via the data transfer connection.

According to some embodiments, the instrument can be controlled through various methods, for example, through the use of software programs implemented for execution on a computer within the infrastructure, or through the use of software programs implemented for execution on more than one computer within the infrastructure. The instrument can also be controlled through the use of software programs located on one or more computers located outside of the infrastructure that can connect via an internet. According to some embodiments, the instrument can be controlled manually. The system can be configured such that software can be implemented, contained, or placed on one or more computers contained in the infrastructure. The one or more computers can request and can receive data from the instrument using the software.

In some embodiments, a user, through the software, can instruct the instrument to perform a reaction, modification, analysis, calibration, or some other instrument function or life science process. The data from this reaction can be sent to a computer, or it can be sent to multiple computers contained in the system infrastructure. According to some embodiments, the data can also be sent to one or more computers contained outside of the system, via an internet. The data can be sent by the user, or by the system, and the system can be configured to automatically send data to one or more of the computers, objects, or other components within the system and/or outside the system.

### Security

According to various embodiments, the infrastructure can be configured to support a diverse range of possible constraints, restrictions, and other variations. These configurations can allows multiple types of users or clients to access the life science instrument infrastructure, and it can allow each to be constrained in different ways. Even with multiple types of users and multiple types of constraints, the system infrastructure allows, in some embodiments, for each type of user to perform the primary purpose or purposes of the system, for example, data collection, data analysis, or some other purpose.

According to various embodiments, the infrastructure can comprise different types of user settings. Each of the users can have access or be limited to different constraints or restrictions, for example, a technician user, a scientist user, a lab manager user, or another type of user. The lab manager user, for example, can access and adjust all of the instrument protocols, rules, formats, and standards, and/or access and adjust data of the infrastructure. This can comprise access to the hardware components, for example, one or computers, one or more objects, and/or one or more other hardware components. The lab manager user can also access the software components, for example, the security, the system architecture or plumbing, the method of validating data received, the method of data analysis, any of the other software modules, or a combination thereof. The technician user, for example, can be restricted from adjusting any of the protocols, rules, formats, or standards of the instrument, and data of the infrastructure. This includes both hardware and software. The restrictions or constraints can also allow for a variety of user constraints that fall somewhere between the restrictions of the lab manager user and those of the technician user. For example, in some embodiments, a scientist user can access and adjust some of the protocols, rules, formats, or standards of the infrastructure. These examples are not meant to limit the types of constraints and types of users that can be deployed on the system, and it will be appreciated that other types of constraints can be used.

According to various embodiments, across this breadth of configurations there can be a range of security related requirements that are met, for example, the requirements under 21 C.F.R. Part 11, regarding electronic signatures. According to various embodiments, the instrument infrastructure can be configured to authenticate users, for example lab manager users, scientist users, technician users, or other types of users. The infrastructure or system can also provide appropriate mechanisms to support a variety of data security programs or methods. These data securities can discover and report when unauthorized data modification occurs, and they can also stop or prevent such unauthorized data modification. The data securities can also support various requirements, for example, regulatory requirements associated with clinical products and their software security, for example, in-vitro diagnostics compliance.

According to various embodiments, the infrastructure can comprise a software self-validation process that can validate any software module, such as a software component, application, service, or other program, before that program can be allowed to execute within the system or infrastructure. An example of software self-validation can comprise validation involving calculating and persisting a digital fingerprint from the infrastructure. At run time, when a software module is being executed, its current digital fingerprint can be calculated and compared with the previously persisted fingerprint of that module, and the software module can be disallowed to run and execute if the fingerprint does not match. It will be appreciated that this is one example of software self-validation, and is not meant to limit the methods that can be used to validate software modules that can be contained within the infrastructure. According to various embodiments, the system can preclude unauthorized external access to the system elements as well.

### Architecture

According to some embodiments, the instrument infrastructure can comprise various service oriented software architectures or other types of architectures, for example, client-server, peer-to-peer, publish-subscribe, data sharing, monolithic applications, or any other software architectural method. These various architectures can be constructed alone, or in any combination with each other. The software can be constructed from different modules. These modules can be software elements of the instrument infrastructure, and can operate within that system independently from the operations of the other modules. Examples of software modules include a software component, an application, a service, or another type of instruction, segment of code, or process. The software can be commercial vendor software, open source software, in-house created software, or any other type of software available. The instrument infrastructure or architectures can be built and/or maintained in various component and connector-based relationships and methods. As referred to herein, software components can comprise a combination of one or more software modules that are combined, executed, run, and compiled to produce a useful process, for example, data collecting or data analysis. Software components can comprise decomposed portions of the instrument infrastructure divided into elements that each carry out a specific function or functions of the architecture or of the system infrastructure. These software components can request or control one or more of the software applications, services, instructions, or a combination thereof, to perform the purpose or purposes of the component.

According to various embodiments, examples of software components for a life science instrument infrastructure can comprise, but are not limited to, data collection components, server programs or components, messaging components, primary data analysis components, secondary data analysis components, instrument data gathering components, and various other types of components. In some embodiments, every computer contained in the life science instrument infrastructure can have separate instances of each component located within. In some embodiments, each of these components can also be implemented to run and execute on each of the computers. In some embodiments there can be instances of some components implemented to run and execute on a centralized server computer. A user can view these software components through a graphical user interface (“GUI”), that can allow users to interact with the computer, and it can allow users to control the computer and devices incorporated within the life science instrument infrastructure. The infrastructure can also be designed so that only a portion of the software components can be visible to the user, depending on which type of user is accessing the system or infrastructure. This can allow for multiple users, with different constraints, to use the same system infrastructure. In some embodiments, only some of the components can be installed and executed on the computers located within the infrastructure.

According to various embodiments, the software modules, such as the components, services, and applications, can be adapted to send, persist, and receive data and instructions to and from other software modules, for example, software services that send and receive data and instructions from other software services within the infrastructure. In one example, a server program can manage those software modules that are deployed and executed as services. The software modules can be adapted to manage inter-process messaging, for example, a software messaging component can manage messaging between different services. Data collection components can be capable of managing the creation and modification of data and the services related to data collection. In some embodiments, some software components can be adapted to control the life sciences instrument. These services can comprise, but are not limited to, the services that perform a setup on the instrument, perform a run of the instrument, request instrument data, perform post run analysis on the data, and communicate with other components about the state of the instrument and associated data. According to various embodiments, the software components and the software services can be adapted to perform primary analysis and/or secondary analysis of the data. The components and the related services can also comprise various types of operating systems, for example, Microsoft Windows or Red Hat Linux. In some embodiments, the components and/or services can gather instrument data and send it to an external website via an internet, for example, the World Wide Web.

According to various embodiments, the software services can be individual segments of code or instructions that can operate independently from other services. The software services can be stateless, they can be reusable, they can be built-in, they can be supportive of one or more business operations, and/or they can be invoked by multiple components and services within the life science instrument architecture. The services can be created or written by the user, they can be open source software, they can be commercial vendor software, or some other type of software. Some services can be capable of one main business operation, for example, a data service. The data service can retrieve a specific piece of data from the life science instrument, from another service, or from a data store, and it can send a piece of data to a component, another service, or a specific library or data store. Logic services can be used to do calculations, for example, a base-calling service can be invoked that reports what type of base a DNA base comprises.

According to various embodiments, some services can be capable of calling other services, for example, the workflow service can organize the order in which other services are to be delivered to a specific software component. A daemon service can instruct the instrument to gather data from the sample reaction, analysis, or other process. A comparative sequence service can compare data that contains sequences of DNA bases to a predetermined reference sequence of DNA. The comparative sequence service can evaluate the sequences of bases in comparison to a predetermined sequence, and it can decide to call the base-calling service again if necessary. A Java message service (“JMS”) can publish messages about the analysis done by the instrument. These are just a few examples of the types of services and how services can interact, in accordance with the present teachings, and they are not meant to limit the many different services that can be utilized in a life science instrument infrastructure, and the manner in which the services interact.

According to various embodiments the software modules of the instrument infrastructure can comprise software components, applications, services, and other instructions. For each computer that is a part of the instrument infrastructure, an instance of each software module can be installed, or only some of the software modules can be installed. Modules can be reused or shared by various components throughout the instrument infrastructure. This reusability or sharing can allow for code to be reused or recycled, and can allow the code to be more facile.

According to various embodiments, software components can send, persist, and receive data and instructions to and from other software services. Software services can also access various data stores and data libraries throughout the instrument infrastructure. In some embodiments, such data stores can comprise various data elements needed by the software components, services, or other processes. According to some embodiments, data stores can be comprised of references, data elements, files, data containers, or other types of data storage. The data elements can be of various types, and can comprise a list of data elements necessary for a specific service, or for a specific component. An example of a data element can be an assay configuration data element that can comprise a group of unified mechanisms that bundle together various data elements needed by the software and associated with performing specific components and services of the infrastructure, for example, a run of the instrument. The assay configurations can comprise subordinate data elements by value, or by reference.

According to various embodiments, a workflow data element can specify what software components should be invoked, by name and version, and in what order to perform various components and services. An instrument protocol data element can comprise the input details for a data collection injection, and can comprise instructions to be sent to one or more computers that control the instrument. A run information data element can comprise all the data elements associated with a run of the instrument and it can comprise both the input and output data. The data element can also comprise files, for example, a spatial calibration file that can comprise instrument data pertaining to the calibration of the instrument. This instrument data can comprise, for example, the instrument calibration settings of the last successful run of the instrument. It will be appreciated that many types of data elements, and many types of data files, libraries, and data stores can be contained within the life science instrument architecture.

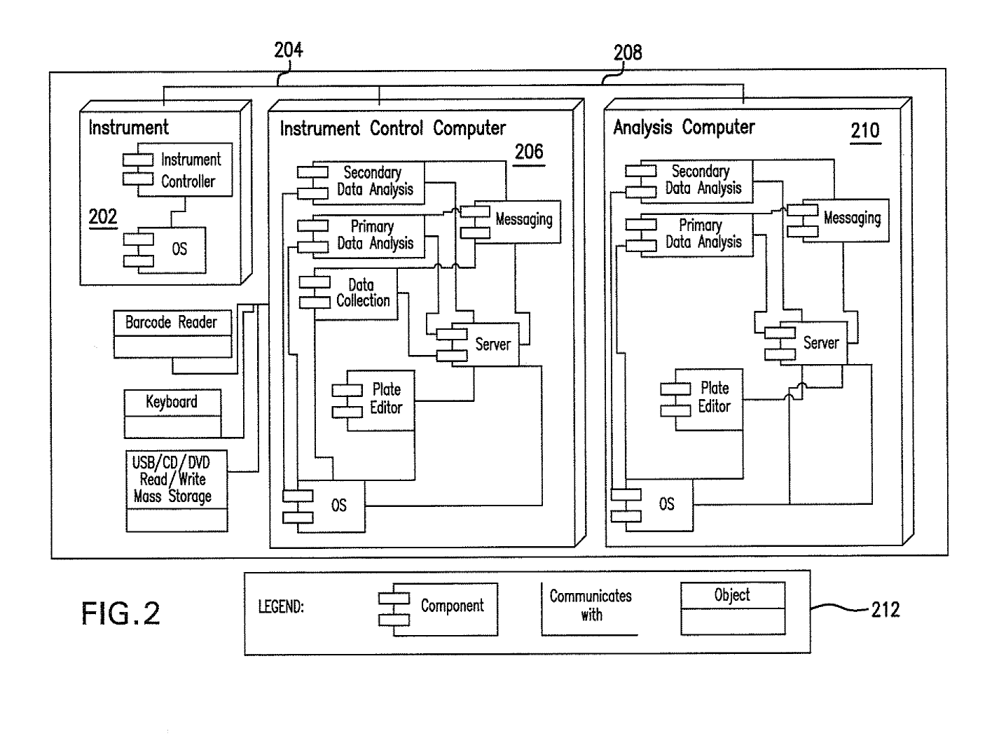

According to various embodiments, an example of an instrument infrastructure comprising hardware and software modules can be schematically shown, for example, as illustrated in FIG. 2. As shown, a life science instrument infrastructure can comprise a life sciences instrument 202 that can have a direct data transfer connection 204 to an instrument control computer 206. Instrument control computer 206 can have a data transfer connection via a LAN 208, to an analysis computer 210. Life sciences instrument 202 can have various software components implemented therein for execution, and running some of the time, or all of the time, for example, an instrument control component and an operating system. The legend 212 in FIG. 2 shows the different software components, and hardware objects. FIG. 2 also shows what components and objects can send, persist, and receive data and instructions to and from other components within the life science instrument infrastructure. While this example comprises two computers within the life science instrument infrastructure, it will be appreciated that the infrastructure can be comprised of one computer or more than two computers. As shown in FIG. 2, an operating system can be implemented for execution on one or more of the computers. This operating system can be any of the available operating systems, for example, Microsoft Windows. Life sciences instrument 202 can be a capillary electrophoresis analyzer and can comprise software modules that can be implemented for execution, for example, an instrument control software component that can control all of the instructions necessary to run the capillary electrophoresis instrument.

According to various embodiments, instrument control computer 206 and analysis computer 210 can comprise software components and/or modules implemented therein for execution. Each can have an operating system, a primary data analysis, and a secondary data analysis for analyzing data. Both computers can also comprise a server program or server component implemented therein for execution, which can manage the software components of that particular computer. They can each be implemented with a messaging component that can manage inter process messaging between the different software components on each computer and between different software components on different computers. A plate editor component can also be provided to manage, create, and modify records of microtiter plates used by instrument 202 and the data resulting therefrom. One difference between the components of instrument control computer 206 and of analysis computer 210, can be the data collection component contained on instrument control computer 206. The data collection component can allow for instrument control computer 206 to send requests to, and receive data from, the instrument. While this example shows the data collection component only on instrument control computer 206, it can also be located on analysis computer 210 in some embodiments. It will be appreciated that any of the components can be left off of either computer.

According to some embodiments, the system infrastructure does not need to receive commands from a user for the instrument to send, persist, and receive data, or for the infrastructure to perform operations within itself. Software components within the instrument infrastructure can be designed such that software modules, for example, components, applications, and services, can call each other at predetermined times, or at times when the system itself determines such a call is necessary.

### Shared-Data Architecture

According to various embodiments, the life science instrument infrastructure can comprise different system architectures. These architectures can be represented by different views. It will be appreciated by one skilled in the art that the different architectures detailed herein are only meant to serve as examples, and it will also be appreciated that many different types of system architectures can be utilized according to the present teachings. One type of architecture that can be implemented into the life science instrument infrastructure can comprise a shared-data architecture. In this type of architecture, each software component can send and retrieve data from each of the data stores or libraries contained in the infrastructure. This access can be through the system server program or server component. While the following example shows the use of one computer, the infrastructure can comprise more than one computers, and those computers can each have shared-data architecture, or some other type of architecture, for example, peer-to-peer, publish-subscribe, monolithic, or a combination thereof. The server program or server software component can be an SOA server software, or other type server software, implemented for execution, and running on any and/or all of the computers in the infrastructure. The SOA server software can allow for data and instructions to be sent and received between the different software modules on one computer and software modules on another computer or instrument, within the life science instrument infrastructure. This access can allow data and instructions to be sent and received to and from the various computers and/or instrument or instruments within the infrastructure.

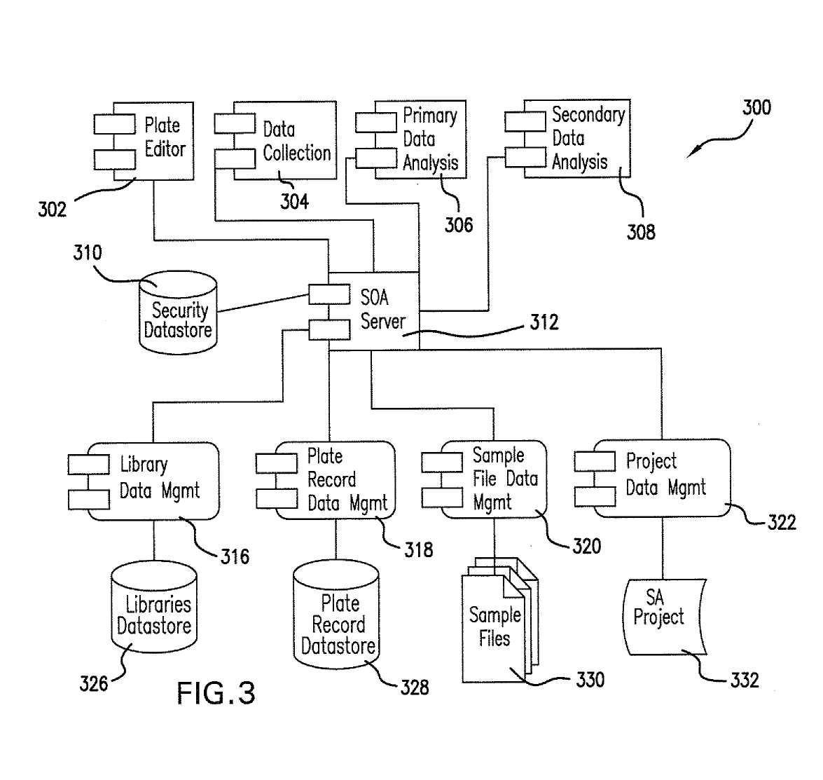

According to various embodiments and as illustrated in FIG. 3, a shared-data instrument architecture 300 is provided according to the present teachings and can comprise various software components, such as, a plate editor 302, a data collection component 304, a data analysis component 306, and a secondary data analysis component 308. A user can use a computer, for example, an instrument control computer (not shown), to access the different software components running or executing within the instrument infrastructure. The instrument infrastructure can be implemented with security components that require and request a password, license key, a combination thereof, or some other form of verification from the user. When this data is entered, it can be compared with already stored data contained in a security data store 310. Security data store 310 can comprise information that tells the components and services which types of constraints or restrictions the user has, and can tell the instrument infrastructure which software components to make visible to the user. These components can be made visible on the monitor or display in the form of a GUI. One or more GUI's can be displayed on the monitor or display, and one or more components can be made available to the user in each GUI. In some embodiments, the infrastructure can allow for a single GUI to display all of the available software components to the user.

According to various embodiments, each of the software components (plate editor 302, data collection 304, primary data analysis 306, and secondary data analysis 308) implemented in a shared-data architecture infrastructure can send, persist, and receive data and instructions to and from the server software component or components, for example, SOA server software 312. SOA server software 312 can send, persist, and retrieve data and instructions to and from any and all of the instrument infrastructure services. These services can be used to send and receive data and instructions from other services, and they can also send and receive data and instructions from the data stores and data libraries within the instrument infrastructure. With this access, each of the software components can send a message or instruction to SOA server software 312, and the server can then access any of the necessary services. The services can then access the data stores and data libraries. These access methods can allow for each of the software components to have access to each of the services and data stores of the system. In such an architecture or infrastructure, all of the software components can share the data stored and contained in the data stores and data libraries within the instrument infrastructure.

According to various embodiments, the data stores can be of any type and size. The data stores can use a variety of underlying technologies to persist the data, for example, flat files, object-oriented databases, and relational databases. The data stores can be built such that a particular data store can comprise all the particular data elements necessary for a specific service or protocol to run or execute. For example, SOA server software 312 can persist and retrieve data from library services, such as library data management service 316, that can persist and retrieve data elements from library data store 326. Library data store 326 can comprise various libraries of data elements, for example, assays, instrument protocols, analysis protocols, or other references. Plate record management service 318, can persist and retrieve data elements from plate record data store 328. Plate record data store 328 can comprise data elements of sample plate records and sample plate record templates. Data services, such as sample file data management service 320, can persist and retrieve data elements from a library of sample files 330. These sample files can individually comprise data elements for each sample file data management service 320, such as, sequencing data, fragment analysis data, and other types of data elements. Management services, such as project data management service 322, can persist and retrieve data elements from secondary analysis project 332. Secondary analysis project 332, for example, can comprise data elements such as access restrictions for a particular user, data distribution, types of data stored, and other elements related to project data management services 322. The previously explained data stores and services are not intended to limit the possible types of data storage structures that can be used. While in the above example the services only persist and retrieve data from one data store, or data library, it will be appreciated that a service can persist and retrieve data from multiple datatstores and/or data libraries.

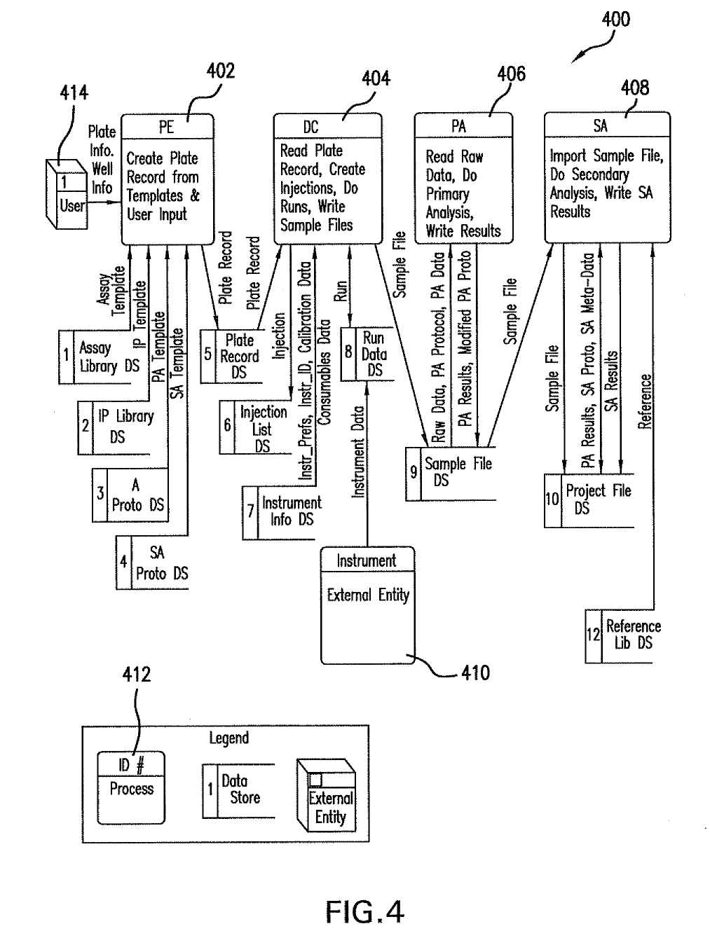

According to various embodiments, the shared-data architecture can be viewed in a shared-data workflow diagram 400, as illustrated in FIG. 4. The software modules, for example, the components and services, can work together with each other to persist and retrieve data from different data stores. A workflow diagram can depict a configuration of what software components persist and receive data from what data stores, and how those components relate with each other. Not shown are the different services that can be working to achieve this access. It will be appreciated that the abbreviation “DS” in FIG. 4, refers to a data store. The legend 412 identifies the different types of elements in the shared-data workflow diagram 400. The following figure shows a workflow diagram between four software components, and illustrates how individual data stores can have data both persisted and retrieved by separate software components with or without the use of services. The software components can also send data to the data stores directly, with or without the use of services.

According to various embodiments and as illustrated in FIG. 4, the shared-data workflow diagram 400 can comprise software components, for example, plate editor (PE) 402, data collection (DC) 404, primary analysis (PA) 406, secondary analysis (SA) 408, and External Entity 410. As shown, a user 414 can access the components through an interface, for example, through a GUI interface that can be implemented in a computer within the instrument infrastructure. User 414 can enter plate information and well information that the software components can retrieve and use. For example, plate editor 402, can persist and retrieve data from an assay library data store, an IP library data store, a primary analysis protocol data store, and a secondary analysis protocol data store. Taking data from each of these data stores, plate editor 402 can create a plate record. This plate record can be sent to and stored in a plate record data store.

According to various embodiments, data collection 404 can, for example, run a setup on the instrument, tell the instrument to execute a run, persist and receive data from the instrument, and persist and receive data regarding a run. Data collection 404 can also persist and retrieve data from the plate record data store. Data collection 404 can send and receive data from the instrument information data store that can comprise current information specific to the instrument, to the preferences, to consumables used by the instrument, or to other instrument information. Data collection 404 can also send and receive data from an injection list data store that allows for disaster recovery. In some embodiments, data collection 404 can persist and retrieve data from the run data store that can comprise data specific to each run of the instrument, whether past or current.

According to various embodiments, software components can communicate with both hardware and software, for example, External entity 410 can be the link between the software components of the computers, and the instrument itself. External entity 410 can be firmware, software, or some other instruction that manages communications with the instrument itself, and it can instruct the instrument to perform a run, for example, a base-calling or size-calling process. External entity 410 can send instructions to the instrument, and it can read results from the instrument. External entity 410 can send the raw instrument data results to a data store, for example, the run data store. Components such as data collection 404 can access the raw instrument data results from the run data store. Data collection 404 can send the raw instrument data in the form of a sample data file to the sample file data store.

According to some embodiments, primary analysis component 406 can retrieve the stored data files from the data stores, for example, from the sample file data store. After receiving the data, primary analysis component 406 can perform analysis on the data, for example, sequencing analysis, fragment analysis, or some other type of analysis. Analysis components, such as primary analysis component 406, can convert the raw instrument data into human-usable information or data. Primary analysis component 406 can send the human-usable data back to a sample file, for example, the sample file data store. Secondary analysis component 408 can persist and retrieve the human usable sample files from the sample file data store and perform analysis to produce results needed by the user, for example, comparative sequencing results, micro-satellite allele calling results, or some other analysis results. Once this analysis has occurred, secondary analysis component 408 can send the analyzed data to another data store, for example, to a project data store.

### Peer-to-Peer Architecture

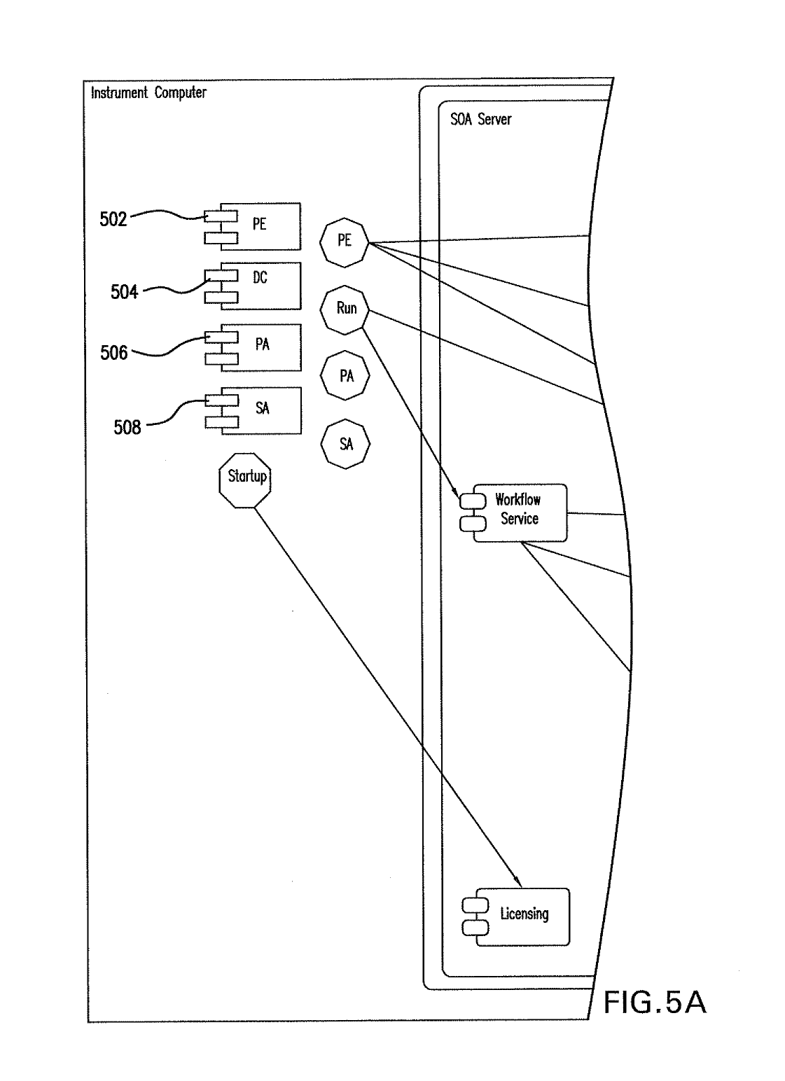

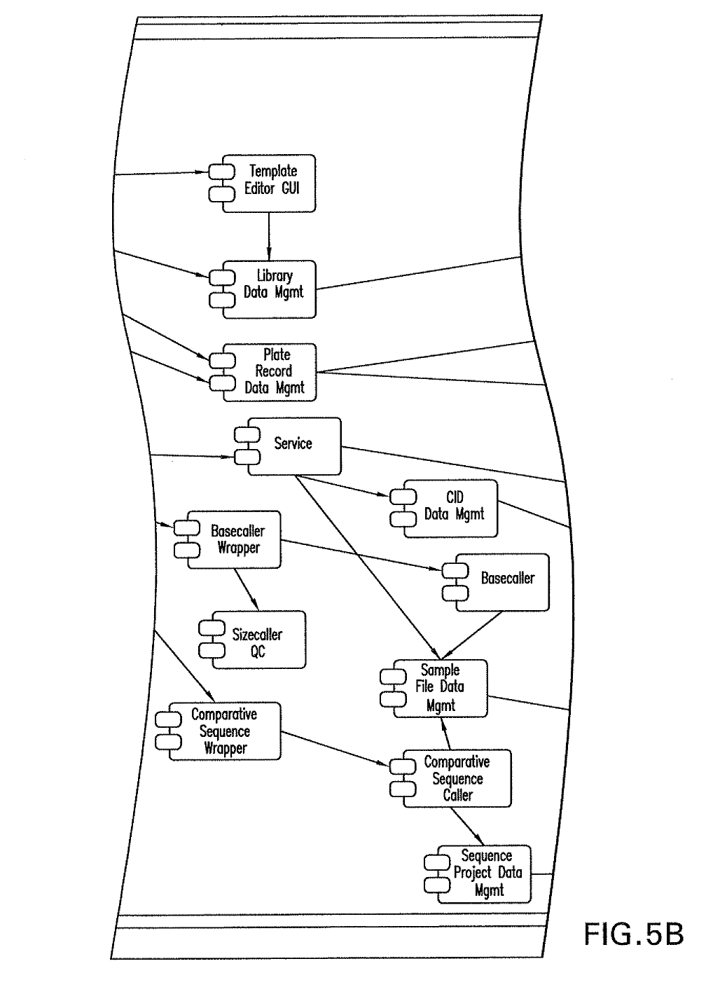

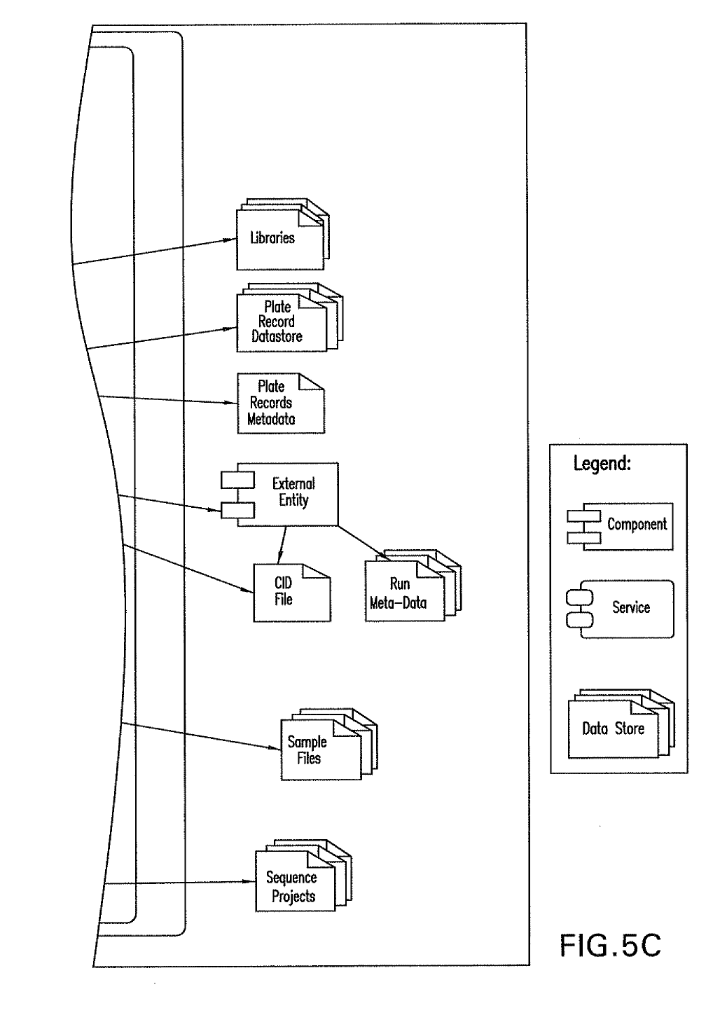

According to various embodiments, other types of architecture can be deployed or implemented for execution in the instrument infrastructure. As illustrated in FIGS. 5A-5C, a peer-to-peer architecture can be implemented in each computer contained in the instrument infrastructure. In this example, only one computer is illustrated, but more than one can be contained on the system. In some embodiments, the additional computer or computers can also implement peer-to-peer architecture, or can implement a different type of architecture, for example shared-data, publish-subscribe, monolithic code, or some other type of architecture. In a peer-to-peer architecture, components can directly interact as peers by exchanging services. Each software module can comprise a set of instructions that allow it to communicate with other software modules. These modules of software, for example, components, services, and data stores, can be implemented into computers within the life science instrument infrastructure. A software component can send, persist, and retrieve data and instructions to and from the server software, for example, SOA server as shown in FIG. 5A. The server software can comprise various services that can send, persist, and retrieve data and instructions to and from the software components implemented on computers within the infrastructure.

According to various embodiments, peer-to-peer communication can be a kind of request/reply interaction without the asymmetry found in the shared-data architecture. In this type of architecture any software component can interact with any software service by requesting that service directly. Each component can comprise instructions, code, modules, components, or other instructions that allow it to send requests and to receive requests from services. This allows for the components to send, persist, and retrieve data and instructions from the services. The services can comprise instructions that allow it to send and receive requests from other services, data libraries, and data stores. Connectors in this style can involve complex bi-directional protocols of interaction that can reflect the two-way communication that can exist between two or more peer-to-peer modules. This can allow for software components to access all of the software services and data stores through the use of the services.

According to various embodiments and as illustrated in FIGS. 5A-5C, a peer-to-peer instrument architecture can comprise various software components. A first section of the peer-to-peer architecture can be seen, for example, in FIG. 5A where components such as a plate editor (PE) 502, a data collection (DC) 504, a primary analysis (PA) 506, and a secondary analysis (SA) 508 can be stored, installed, implemented, and ready for execution on a computer within the life science instrument infrastructure. FIG. 5A shows an instrument control computer where the software components are accessed by a user, via a GUI. Each component can be contained in a GUI program that can execute and run on any of the instrument infrastructure computers. The GUI program can be viewed on a display or monitor that can allow the user to interact with the software components by the input of commands into the GUI program using a device connected to the computer, such as a keyboard or mouse. The GUI program can send these commands through the different components and services. These software components can send, persist, and retrieve data and instructions to and from the server software, for example, SOA server software installed on the instrument control computer, as shown.

According to various embodiments, the software components in a peer-to-peer architecture as shown in FIG. 5A can send and retrieve data and instructions to and from the software services, as shown in FIG. 5B. These services can be implemented for execution within one or more computers within the life science instrument infrastructure. It will also be appreciated that services can be implemented on one computer, and not implemented on another computer within the life science instrument infrastructure. As shown in FIG. 5A, a component such as plate editor 502, can be selected by the user to create a plate record. Plate editor 502 can persist and retrieve services directly as shown in FIG. 5B, for example, template editor, library data management, and plate record data management. Each of these services can be implemented in server software component 510. Plate editor 502 can persist and retrieve data and instructions from each of these services. According to some embodiments, in peer-to-peer architecture, the services can persist and retrieve data and instructions to and from each other, for example, the template editor can connect directly to the library data management. The services can also persist and retrieve data from one or more data stores or libraries as shown in FIG. 5C, for example, the plate record data management service can persist and retrieve data from the plate record data store and the plate record meta-data store.

According to various embodiments and as illustrated in FIGS. 5A-5C, data collection component 504 can be used to access data from an instrument run. Data collection 504 can persist and retrieve data and instructions with the plate record data management service and the workflow service. The workflow service can then invoke various other services located within the server software, or persist and retrieve various other libraries or data stores located within the computer. These illustrations can be useful to show the various types of peer-to-peer interactions that can occur between software components, services, data stores, and libraries. It will be appreciated that performing a data collection run of the instrument is just one component that can be performed by the system, and various other components can be performed, for example, primary analysis, secondary analysis, licensing, data management, and any other type of service that can be performed in the life science instrument architecture.

### Publish-Subscribe Architecture

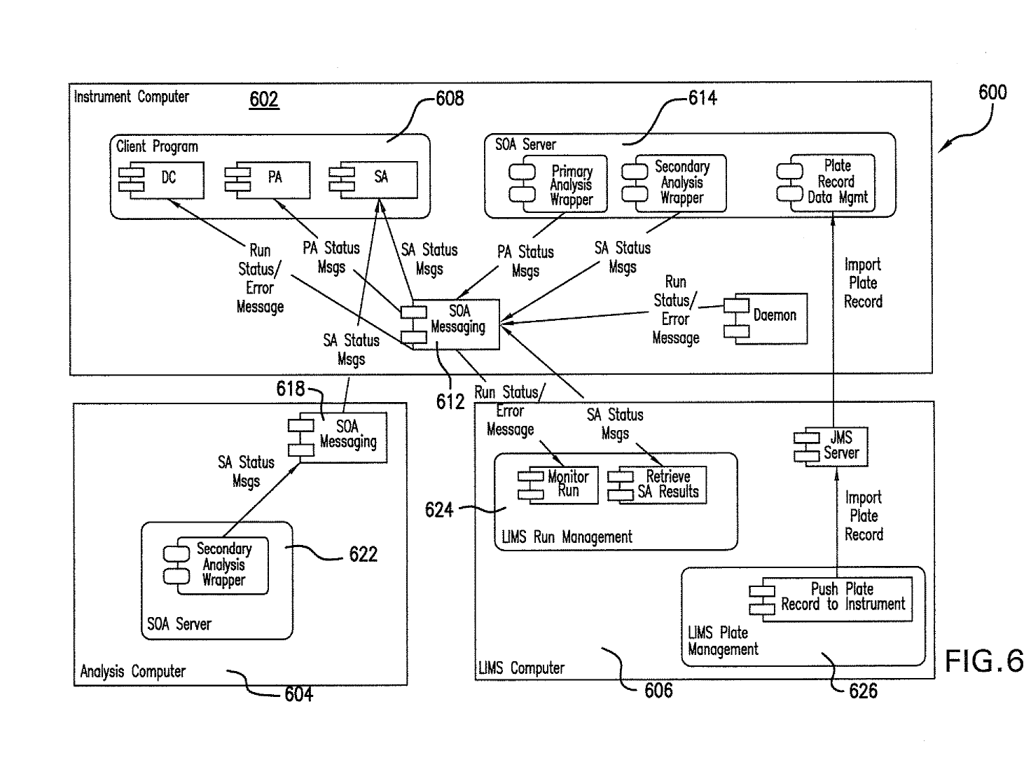

According to various embodiments, a publish-subscribe architecture can be implemented into the life science instrument infrastructure. In the publish-subscribe architecture, software components can subscribe to a set of events. The components can send a published event, for example, the data collection component contained on a computer inside the system infrastructure can send out an instrument information data event. This event can be published on a connector contained in the instrument infrastructure, for example, on an event bus. Other components can subscribe to a set of events. Software components can publish their events on the event bus, and the bus can deliver those published events to software components and services that subscribe to those events. This delivery method can allow for components and services to send, persist, and retrieve data and instructions from other components and services without actually knowing which component or service will receive the event. An example of a publish-subscribe architecture is shown in FIG. 6. The instrument infrastructure can comprise any number of computers, and each computer can be implemented with publish-subscribe architecture, or another type of architecture, for example, shared-data, peer-to-peer, monolithic, or some other type of architecture.

According to various embodiments, and as shown in FIG. 6, a life science instrument publish-subscribe infrastructure can be viewed in a publish-subscribe instrument architecture 600. For this example, three computers are used, an instrument control computer 602, an analysis computer 604, and a laboratory information management system (“LIMS”) computer 606. Inside of instrument control computer 602, a program, for example, a client program 608, can comprise all of the GUI elements for the various application components, such as, plate editor, data collection, primary analysis, and/or secondary analysis. Inside of client program 608, the different software components and services can publish events and subscribe to events by contacting an SOA messaging component 612.

According to various embodiments, instrument control computer 602 can have other software programs, for example, an SOA server program 614 that can be implemented to run and execute on that computer. The SOA server program 614 can host various software components and services that can subscribe to SOA messaging component 612. When a published event is sent to SOA messaging component 612, SOA messaging component 612 can determine which of the software components and/or software services subscribe to a specific event, and it can publish that event to that component or service. An example of this can be the primary analysis component of the client program 608 publishing an event to SOA messaging component 612. SOA messaging component 612 can then determine which of the services and/or software components subscribe to that published event, and they can deliver the published event to that service or program, for example, they can deliver the primary analysis published event to the primary analysis wrapper service, located within SOA server program 614. In this regard, the SOA messaging component can send and receive data and instructions to and from the components, and it can send, persist, and receive data and instructions to and from the services. This example is not intended to limit the publish-subscribe system architecture, and it is not intended to limit the different programs, components, services, and virtual machines that can be contained within publish-subscribe instrument architecture 600.

According to various embodiments, analysis computer 604 can be implemented with an SOA messaging program 618. Analysis computer 604 can also be implemented with an SOA server component 622 that can be executed or run on that computer. SOA server messaging component 612 can receive published events from different software components and services, for example, the secondary analysis component running on instrument control computer 602, and it can deliver the published event to one or more software services or components that subscribe to that event, for example, a secondary analysis wrapper service. Analysis computer 604 and the instrument control computer can be connected via direct connection, via a LAN, via an internet, or via any other method of connection.

According to various embodiments, LIMS computer 606 can comprise software components and services that can be used to manage the laboratory, the biological samples, the users, workflow automation, and various other programs and components implemented for execution in a LIMS computer, for example, a LIMS run management program 624 and a LIMS plate management program 626. Inside each of these programs, software components and services can publish and subscribe to SOA messaging component 612 of instrument control computer 602. The computers can be connected to each other via a direct connection, via a LAN, via an internet, or via some other form of connection.

### Replaceability

According to various embodiments, service oriented architecture components, services, applications, and other instructions can be reused, replaced, removed, or added to the computers and/or the life science instrument, while the instrument is currently in use. This can allow for different types of users to modify the system without re-validating the entire system. Examples of this can comprise adjusting services, components, code, or other instructions, to upgrade to a new method of that service, component, code or instruction. This can be done by replacing the current module with a separate, newer software service or component. In some embodiments, the replaceability can allow for a user of the system to run, and gather data from the instrument, while at the same time one can add new software components to be installed in parallel.

According to various embodiments, new software modules, for example, services can be added with minimal re-validation required depending on which modules were added and their relationship with existing modules. For example, if you installed a new version of a basecaller service, and left the previous version alone, you only have to do minimal re-validation of the system to demonstrate that they were completely independent, and existing components can use the older version of the basecaller and can be unaffected.

Software modules within an SOA can be much more readily replaced than within a traditional monolithic client environment. The software modules can be more loosely coupled both physically and architecturally within the life science instrument infrastructure. This can be accomplished by creating software modules that operate independently of one another. One of the key benefits to an SOA can be the ease of adding, removing, and replacing a software service while minimizing the impact on the existing system. The services implemented within the life science instrument infrastructure can run within a service broker. An example of a service broker can be a common object request broker architecture (“CORBA”) that allows for software components and services written in multiple computer languages and running on multiple computers, to send, persist, and retrieve data from each other.

According to some embodiments, the services can also be registered with a service registry. The service registry, for example, can contain information about available services implemented throughout the life science instrument infrastructure. The SOA infrastructure can comprise mechanisms that can allow the SOA infrastructure to update an existing service with a newer version, for example, install and register, and as long as the new version of the service supports the same published interface or interfaces, conforming to the ‘Open/Closed Principle’, the replacement can be transparent to any of the service clients. The SOA infrastructure mechanisms for adding and replacing services can comprise installing the software service code into a known location, and the SOA Server can run an operation that can register the service and can make it available for invocation.

Other embodiments will be apparent to those skilled in the art from consideration of the present specification and practice of the present teachings disclosed herein. It is intended that the present specification and examples be considered as exemplary only.

What is claimed:

1. A life science instrument infrastructure, comprising:
one or more computers;
a plurality of software components implemented for execution on the one or more computers, and comprising a plurality of software modules;
a life science instrument;
one or more software components implemented for execution on the life science instrument;
a data transfer connection connecting the life science instrument to at least one of the one or more computers; and
a network comprising a service oriented architecture implemented for execution on each of the one or more computers, wherein each of the one or more software components implemented for execution on the life science instrument are networked with each of the plurality of software components implemented for execution on the one or more computers by the service oriented architecture, and at least two of the plurality of software components share a same one of the plurality of software modules.

2. The life science instrument infrastructure of claim 1, wherein the life science instrument comprises a capillary electrophoresis instrument.

3. The life science instrument infrastructure of claim 1, wherein the life science instrument comprises a real-time polymerase chain reaction instrument.

4. The life science instrument infrastructure of claim 1, wherein the life science instrument further comprises a thermal cycler.

5. The life science instrument infrastructure of claim 1, wherein the data transfer connection comprises a cable.

6. The life science instrument infrastructure of claim 1, wherein the data transfer connection comprises a local area network.

7. The life science instrument infrastructure of claim 1, wherein the data transfer connection comprises an internet.

8. The life science instrument infrastructure of claim 1, wherein the one or more computers consists of two computers.

9. The life science instrument infrastructure of claim 1, wherein the one or more computers consists of three computers.

10. The life science instrument infrastructure of claim 1, wherein the service oriented architecture comprises shared-data architecture.

11. The life science instrument infrastructure of claim 1, wherein the service oriented architecture comprises peer-to-peer architecture.

12. The life science instrument infrastructure of claim 1, wherein the service oriented architecture comprises publish-subscribe architecture.

13. The life science instrument infrastructure of claim 1, wherein the one or more computers comprises two or more computers, the infrastructure comprises a second data transfer connection, and the second data transfer connection connects each of the two or more computers together.

14. The life science instrument infrastructure of claim 1, wherein the life science instrument further comprises a mass spectrometer.

15. A method of networking a life science instrument infrastructure, comprising:
providing a life science instrument and at least one life science instrument software component, wherein the at least one life science instrument software component is implemented for execution on the life science instrument;
providing one or more computers and a plurality of computer software components implemented for execution on at least one of the one or more computers, and comprising a plurality of software modules;
generating a data transfer connection to and from the life science instrument and at least one of the one or more computers;
networking the at least one life science instrument software component and the plurality of computer software components using service oriented architecture, and
sharing at least one of the plurality of software modules, between two or more of the plurality of computer software components.

16. The method of networking a life science instrument infrastructure of claim 15, wherein the networking further comprises establishing a network between the at least one life science instrument software component and the plurality of computer software components using shared-data architecture.

17. The method of networking a life science instrument infrastructure of claim 15, wherein the networking further comprises establishing a network between the at least one life science instrument software component and the plurality of computer software components using peer-to-peer architecture.

18. The method of networking a life science instrument infrastructure of claim 15, wherein the networking further comprises establishing a network between the at least one life science instrument software component and the plurality of computer software components using publish-subscribe architecture.
